(19) United States
(12) Patent Application Publication
(10) Pub. No.: US 2009/0122758 A1
(43) Pub. Date: May 14, 2009

(54) Method and Apparatus for Transmitting HARQ Sub-Packets in a Wireless Communication System

(76) Inventors: Jack Smith, Valley View, TX (US); Anthony C.K. Soong, Plano, TX (US); Sean Michael McBeath, Keller, TX (US)

Correspondence Address: Slater & Matsil, L.L.P., 17950 Preston Road, Suite 1000, Dallas, TX, 75252, US

(21) Appl. No.: 12/269,529

(22) Filed: Nov. 12, 2008

Related U.S. Application Data
(60) Provisional application No. 60/988,022, filed on Nov. 14, 2007.

(51) Int. Cl. H04W 72/04

(52) U.S. Cl. 370/330; 370/329

(57) ABSTRACT

In one embodiment of the present invention, a method and apparatus for the base station to transmit a series of HARQ sub-packets to a mobile station is disclosed. In another embodiment of the present invention, a method and apparatus for the base station to assign radio resources for the mobile station to transmit a series of HARQ sub-packets to a base station is disclosed.

This application claims the benefit of U.S. Provisional Application Ser. No. 60/988,022, filed Nov. 14, 2007 and incorporated herein by reference.

### TECHNICAL FIELD

Embodiments of the present invention generally relate to the allocation of time-frequency resources in a wireless communication system. In more specific embodiments, the present invention can relate to a novel method of allocating time-frequency resources for the transmission of hybrid automatic repeat request (HARQ) sub-packets in orthogonal frequency division multiplexing (OFDM) and orthogonal frequency division multiple access (OFDMA) communication systems.

### BACKGROUND

In wireless communication systems, hybrid automatic repeat request (HARQ) is commonly used to improve capacity. For HARQ, for downlink operation, the base station encodes a packet to form a series of encoded bits. The base station then transmits a first portion of the encoded bits, denoted as the first HARQ transmission. If the mobile station is able to correctly decode the packet after the first HARQ transmission, the mobile station transmits an acknowledgement to the base station. If the mobile station is not able to correctly decode the packet after the first HARQ transmission, the mobile station transmits a negative acknowledgment to the base station. Upon receiving the negative acknowledgement, the base station transmits a second portion of the encoded bits, denoted as the second HARQ transmission, to the mobile station. The mobile station then combines the second HARQ transmission with the first HARQ transmission and attempts to decode the packet. If the mobile station is able to correctly decode the packet after the first and second HARQ transmissions, the mobile station transmits an acknowledgement to the base station. If the mobile station is not able to correctly decode the packet after the first and second HARQ transmissions, the mobile station transmits a negative acknowledgment to the base station. This process is repeated until a maximum number of HARQ transmissions are reached or until the mobile station has correctly decoded the packet.

Multiple HARQ transmissions can be used as a method for distributing the power in the time domain. Unfortunately, for applications like voice over internet protocol (VoIP), where minimizing the delay is critical, the time between subsequent HARQ transmissions can be large. Thus, there is a need for enabling multiple HARQ transmissions while incurring less delay.

### SUMMARY OF THE INVENTION

In one aspect, the present invention provides a method and apparatus for the base station to transmit a series of HARQ sub-packets to a mobile station.

In another aspect, the present invention provides a method and apparatus for the base station to assign radio resources for the mobile station to transmit a series of HARQ sub-packets to a base station.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a wireless communications network;

FIG. 2 illustrates a base station and several mobile stations from a wireless communications network;

FIGS. 3-4 illustrate example sets of OFDMA time-frequency radio resources;

FIG. 5 illustrates an example numbering of slots for an uplink sub-frame;

FIG. 6 illustrates an example assignment message;

FIG. 7 illustrates four example assignment messages;

FIG. 8 illustrates example radio resources for four mobile stations;

FIG. 9 illustrates a sequence of frames for downlink traffic;

FIG. 10 illustrates a sequence of frames for downlink traffic in accordance with one embodiment of the present invention;

FIG. 11 illustrates a sequence of frames for uplink traffic;

FIG. 12 illustrates a sequence of frames for uplink traffic in accordance with one embodiment of the present invention;

FIG. 13 is a flow chart for base station operation in accordance with one embodiment of the present invention; and

FIG. 14 is a flow chart for base station operation in accordance with another embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present disclosure can be described by the embodiments given below. It is understood, however, that the embodiments below are not necessarily limitations to the present disclosure, but are used to describe a typical implementation of the invention.

Embodiments of the present invention provide a unique method and apparatus for transmitting HARQ sub-packets in a wireless communication system. It is understood, however, that the following disclosure provides many different embodiments, or examples, for implementing different features of the invention. Specific examples of components, signals, messages, protocols, and arrangements are described below to simplify the present disclosure. These are, of course, merely examples and are not intended to limit the invention from that which is described in the claims. Well known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art. Details regarding control circuitry described herein are omitted, as such control circuits are within the skills of persons of ordinary skill in the relevant art.

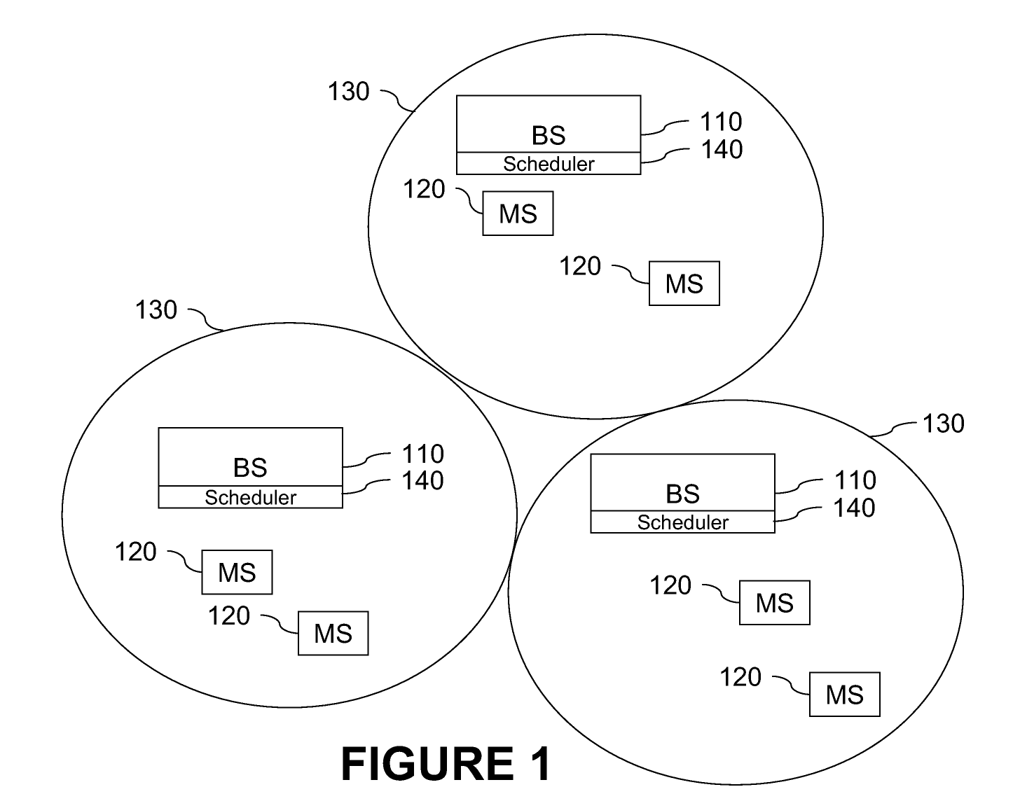

FIG. 1 is a wireless communications network comprising a plurality of base stations (BS) 110 providing voice and/or data wireless communication service to a plurality of mobile stations (MS) 120. The BS is also sometimes referred to by other names such as access network (AN), access point (AP), Node-B, etc. Each BS has a corresponding coverage area 130. Referring to FIG. 1, each base station includes a scheduler 140 for allocating radio resources to the mobile stations.

Exemplary wireless communication systems include, but are not limited to, Evolved Universal Terrestrial Radio Access (E-UTRA) networks, Ultra Mobile Broadband (UMB) networks, IEEE 802.16 networks, and other OFDMA based networks. In some embodiments, the network is based on a multiple access scheme other than OFDMA. For example, the network can be a frequency division multiplex access (FDMA) network wherein the time-frequency resources are divided into frequency intervals over a certain time interval, a time division multiplex access (TDMA) network wherein the time-frequency resources are divided into time intervals over a certain frequency interval, and a code division multiplex access (CDMA) network wherein the resources are divided into orthogonal or pseudo-orthogonal codes over a certain time-frequency interval.

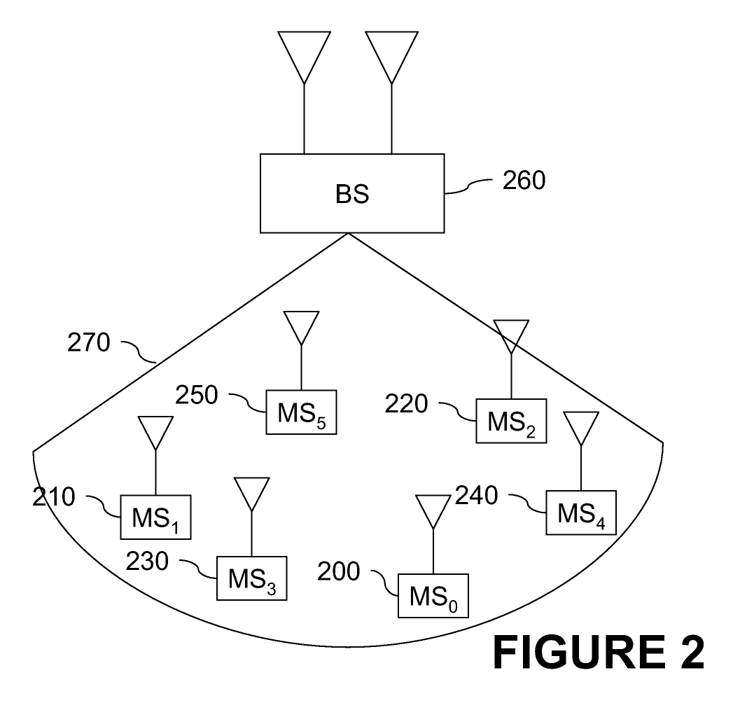

FIG. 2 illustrates one base station and several mobile stations from the wireless communications network of FIG. 1. The base station has three coverage areas in this example, one of which is shown 270. The coverage area is sometime referred to as a sector. Six mobile stations 200, 210, 220, 230, 240, 250 are in the shown coverage area. The base station typically assigns each mobile station one or more connection identifiers (CID) (or another similar identifier) to facilitate time-frequency resource assignment. The CID assignment can be transmitted from the base station to the mobile station on a control channel, can be permanently stored at the mobile station, or derived based on a mobile station or base station parameter.

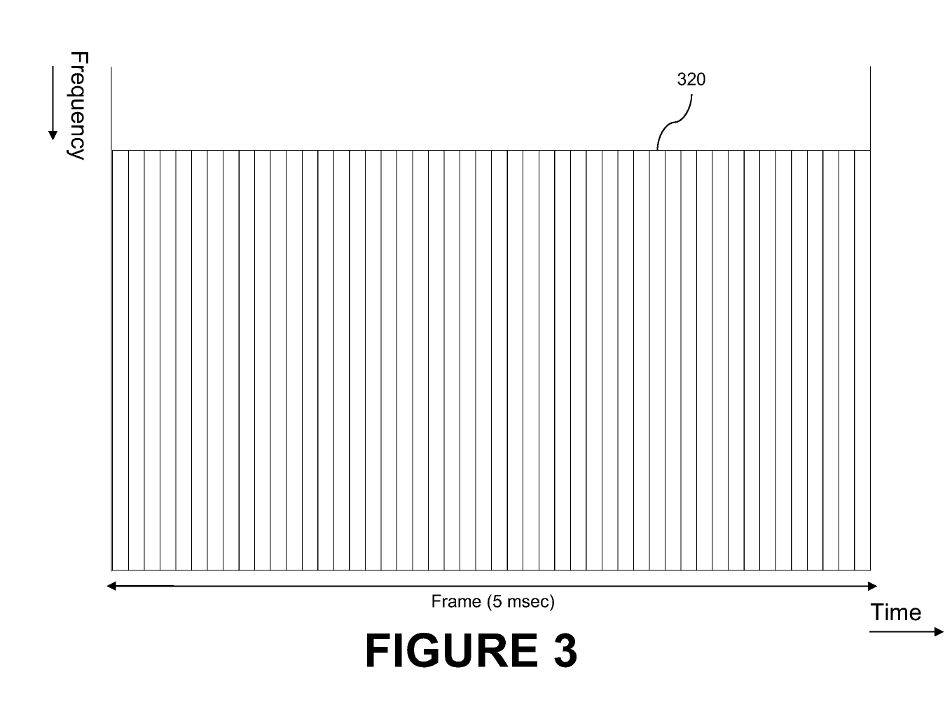

FIG. 3 illustrates an example set of OFDMA time-frequency radio resources. In OFDMA systems, the time-frequency resources are divided into OFDM symbols and OFDM subcarriers for allocation by the base station scheduler to the mobile stations. In an example OFDMA system, the OFDM subcarriers are approximately 10 kHz apart and the duration of each OFDM symbol is approximately 100 μsec. FIG. 3 illustrates one 5 msec frame of an OFDMA system, such as that defined by the IEEE 802.16e standard. Note that 5 msec is one example of a frame duration and that other frame durations are possible.

Referring again to FIG. 3, in this example embodiment, resources in the time domain (x-axis) are divided into 48 OFDM symbols 320. In the frequency domain (y-axis), the resources are divided into multiple subchannels (not shown), wherein the size of the subchannel depends on the subcarrier permutation scheme. A permutation scheme is a mapping from logical subchannels to physical subcarriers. Downlink (DL) partial usage of subcarriers (PUSC), DL full usage of subcarriers (FUSC), and uplink (UL) PUSC are exemplary subcarrier permutations schemes defined in the IEEE 802.16 standard. Other permutation schemes are also defined in the IEEE 802.16 standard, so DL PUSC, DL FUSC, and UL PUSC are merely used to illustrate the invention.

For DL PUSC, for a 5 MHz bandwidth, there are 360 data subcarriers divided into 15 subchannels, wherein each subchannel has 24 data subcarriers. For DL PUSC, the base station must assign an even number of OFDM symbols for each subchannel. For DL FUSC, for a 5 MHz bandwidth, there are 384 data subcarriers divided into 8 subchannels, wherein each subchannel has 48 data subcarriers. For UL PUSC, for a 5 MHz bandwidth, there are 408 subcarriers (data plus pilot) divided into 17 subchannels, wherein each subchannel has 24 subcarriers (16 data plus 8 pilot). For UL PUSC, the number of OFDM symbols for each subchannel must be a multiple of 3.

Note that the subchannels are a logical representation of the time-frequency resources of the system. Each logical time-frequency resource (subchannel) maps to a physical time-frequency resource. The mapping of logical time-frequency resources to physical time-frequency resources depends on which subcarrier permutation is being used. The mapping of logical time-frequency resource to physical time-frequency resources can change with time and can depend on one or more parameters defined by the system.

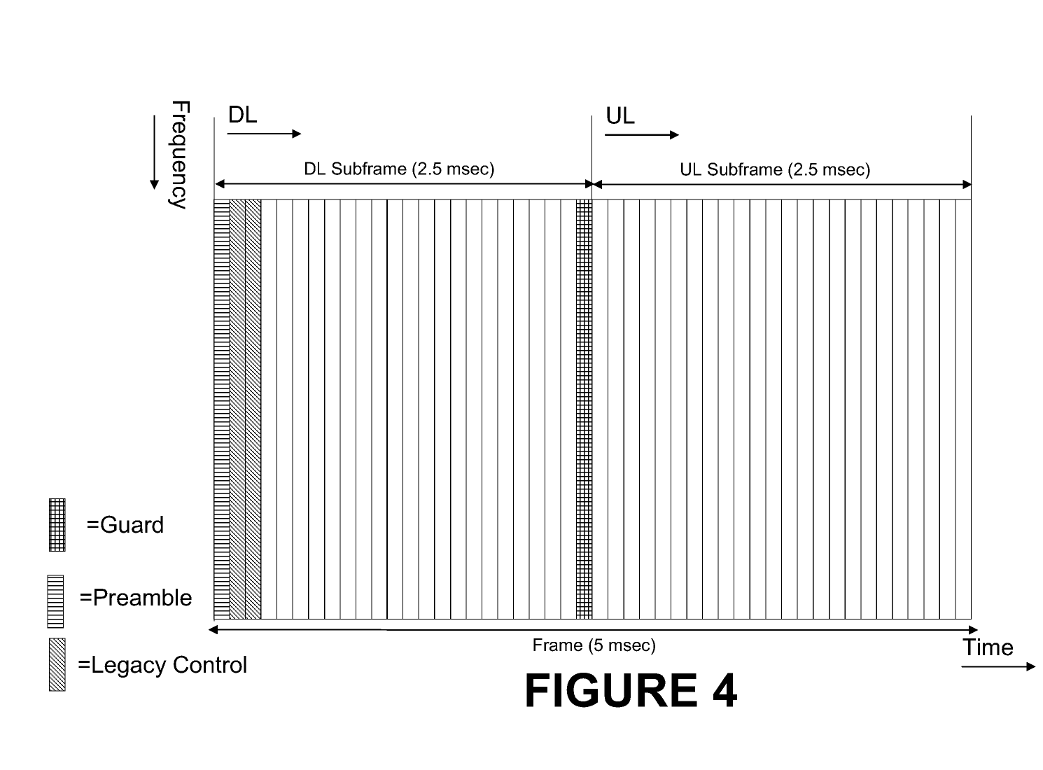

FIG. 4 illustrates the division of the time domain structure of FIG. 3 into a downlink subframe and an uplink subframe. Referring to FIG. 4, the time-frequency resources correspond to a time division duplex (TDD) system, such as that defined by the IEEE 802.16e standard. Note that this invention is generally described for a TDD system, but it also applies equally well for a frequency division duplex (FDD) system, a half duplex frequency division duplex (H-FDD) system, as well as other systems. In this exemplary embodiment, the resources in the time domain (x-axis) are divided into two equal portions; denoted as the DL subframe and the UL subframe. Each of the DL subframe and the UL subframe is comprised of 24 OFDM symbols. The first DL OFDM symbol is allocated for the preamble, which is used for timing and frequency synchronization by the mobile stations. The second and third DL OFDM symbols are used to transmit control information. The twenty-fourth DL OFDM symbol is allocated as a guard period. Note that there is also a guard period following the UL subframe, which is not shown.

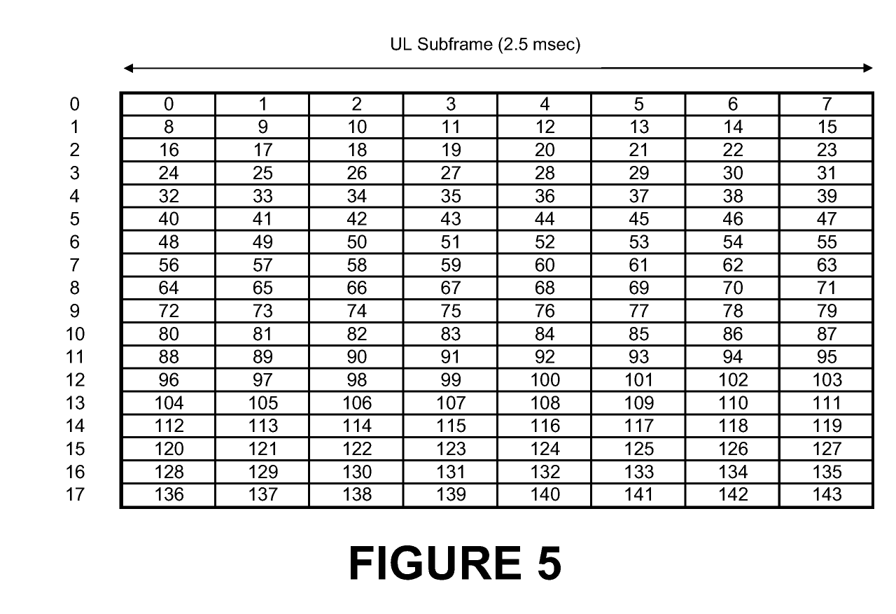

FIG. 5 illustrates an example numbering of slots for an uplink sub-frame. Each slot is 1 OFDM subchannel by 3 OFDM symbols. The slot numbering begins with slot 0 at the first OFDM symbol and the first OFDM subchannel and continues in the time domain until slot 7. The slot numbering then continues at slot 8 at the first OFDM symbols and the second subchannel and continues to slot 15. This process is repeated for all OFDM subchannels as shown in FIG. 5.

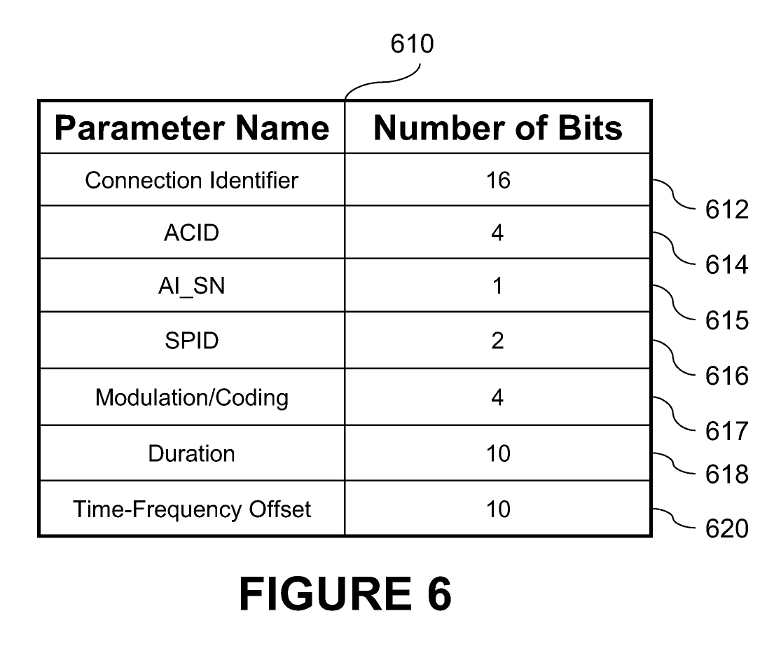

FIG. 6 illustrates an example assignment message. The assignment message 610 contains several fields 612, 614, 615, 616, 617, 618 and 620 and is used by the base station to inform the mobile station of its time-frequency resource assignment and the associated parameters. The connection identifier field 612 is a 16 bit field which is used to uniquely identify the mobile station. The ACID field 614 is a four bit field, which is used to identify the HARQ process. The receiver combines sub-packets having the same ACID prior to decoding. The AI_SN field 615 is a one bit field, which is toggled from ‘1’ to ‘0’ or from ‘0’ to ‘1’ to indicate a new HARQ process. When the receiver observes that the AI_SN field has been toggled, it clears the decoding buffer. The SPID field 616 is a two bit field, which is used to indicate which of a series of sub-packets is being transmitted. For example, if there are four possible sub-packets (corresponding to four HARQ transmissions), the SPID field can take values from the set ‘00’, ‘01’, ‘10’, and ‘11’, each value corresponding to one of the sub-packets. This allows the receiver to determine which sub-packet is being transmitted.

The modulation/coding field 617 is a four bit field for indicating the modulation and coding of the packet. The duration field 618 is a ten bit for indicating the number of time-frequency resources assigned to the connection identifier 612. The time-frequency offset field 620 is a ten bit field for indicating an offset relative to a known starting time-frequency resource. Not all fields are used in all embodiments.

In some embodiments, additional fields are added. The number of bits for each field can change depending on the system and the associated parameters. Further, additional fields may be needed in some embodiments and fewer fields may be needed in some embodiments. For example, in some embodiments, the time-frequency resource assignments for the Nth mobile station depends on the number of time-frequency resources assigned to mobile stations 1, 2, . . . N−1. In such an embodiment, the base station only needs to signal the number of time-frequency resources assigned to each mobile station (duration 618) and does need to signal the time-frequency offset 620.

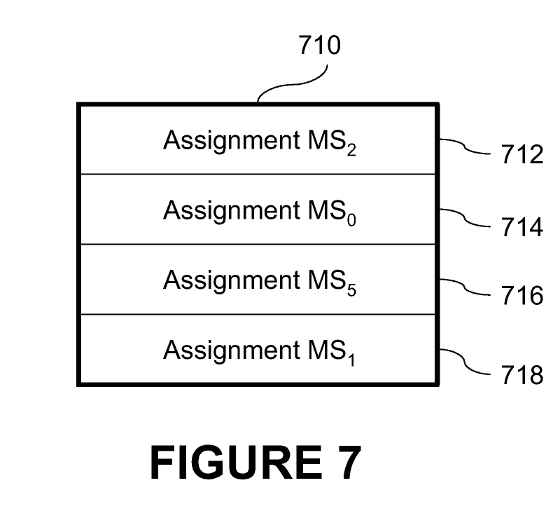

FIG. 7 illustrates an example control channel containing a list of assignment messages. The base station transmits multiple assignment messages, each assignment message indicating an assignment for one mobile station. Considering again the 6 mobile stations of FIG. 2, arranged as depicted on FIG. 2, the base stations transmits assignment messages to MS₂ 712, MS₀ 714, MS₅ 716, and MS₁ 718. Based on the information in the assignment messages, the mobile stations can determine their time-frequency resource assignments and the associated parameters. The order of the assignment messages 712, 714, 716 and 718 is related to the order of the time-frequency resources assigned to the mobile stations. For example, MS₂ is allocated resources first, MS₀ is allocated the resources second (following the resources for MS₂), etc.

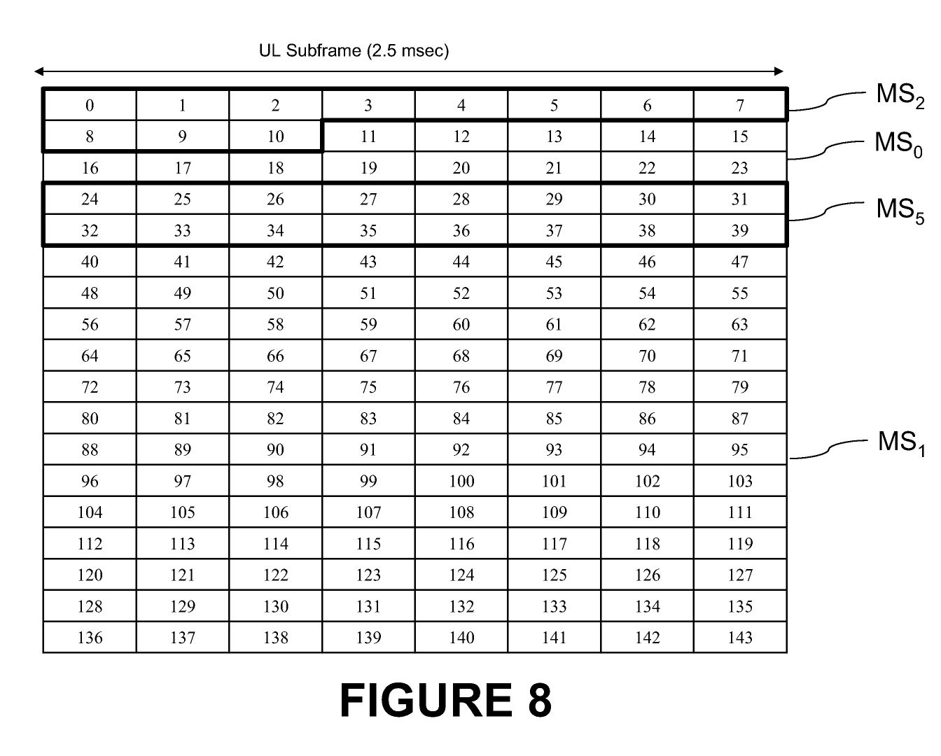

FIG. 8 illustrates example radio resources for four mobile stations. Consider that the base station transmits four uplink assignment messages to four mobile stations as in FIG. 7. If the duration field of the assignment message for MS₂ is 11 (decimal), the duration field of the assignment message for MS₀ is 13 (decimal), the duration field of the assignment message for MS₅ 16 (decimal), and the duration field of the assignment message for MS₁ is 104 (decimal), then the mobile stations determine their time-frequency resource assignments as shown in FIG. 8. In particular, MS₂ is allocated resources first, followed by MS₀, etc.

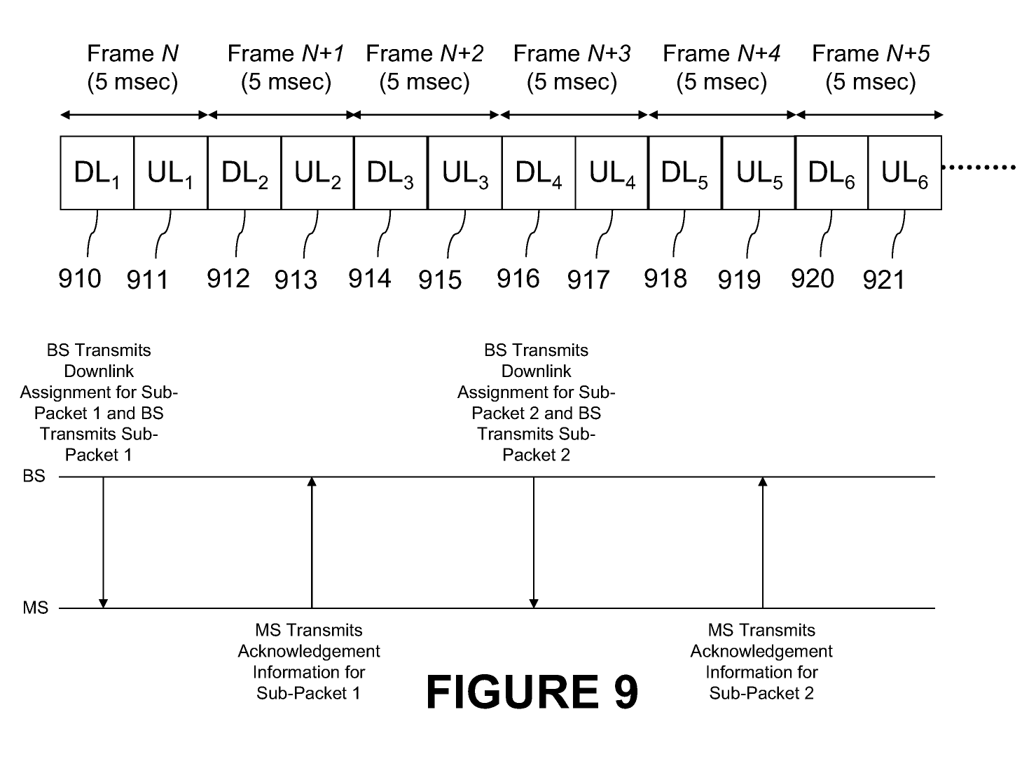

FIG. 9 illustrates a sequence of frames for downlink traffic. Consider that the base station has encoded a packet and has generated multiple sub-packets for multiple HARQ transmissions as previously discussed. In the downlink subframe of frame N (label 910), the base station transmits a downlink assignment for sub-packet 1 and transmits sub-packet 1 (the first HARQ transmission) to the mobile station. Since this is a first HARQ transmission, the base station will toggle the AI_SN field and set the ACID to some value. The mobile station decodes the assignment message, determines it has been assigned a radio resource, and then processes the sub-packet received on the determined radio resource. The radio resource can be a time-frequency resource, a code resource, a time resource, a frequency resource, a spatial resource, combinations, and the like depending on the system type.

If the mobile station is able to successfully decode the packet after sub-packet 1, the mobile station transmits an acknowledgement (ACK) to the base station in the uplink subframe of frame N+1 (913). If the mobile station is not able to successfully decode the packet after sub-packet 1, the mobile station transmits a negative acknowledgement (NACK) to the base station in the uplink subframe of frame N+1 (913). Upon receiving an ACK, the base station takes no further action for this packet.

Upon receiving a NACK, in the downlink subframe of frame N+3 (916), the base station transmits a downlink assignment for sub-packet 2 and transmits sub-packet 2 (the second HARQ transmission) to the mobile station. Since this is a second HARQ transmission, the base station will not toggle the AI_SN field and will set the ACID to the same value that was used in the assignment message of the first HARQ transmission. The mobile station decodes the assignment message, determines is has been assigned a radio resource, and then processes the sub-packet received on the determined radio resource. Since this is a second HARQ transmission, the mobile station combines sub-packet 1 and sub-packet 2 prior to decoding. The combining can be soft combining, hard combining, symbol concatenation, combinations, and the like.

If the mobile station is able to successfully decode the packet after sub-packets 1 and 2, the mobile station transmits an acknowledgement (ACK) to the base station in the uplink subframe of frame N+4 (919). If the mobile station is not able to successfully decode the packet after sub-packets 1 and 2, the mobile station transmits a negative acknowledgement (NACK) to the base station in the uplink subframe of frame N+4 (919). This process is repeated for subsequent HARQ transmissions.

For applications like VoIP, where the delay between when a packet arrives at the base station and when the packet is successfully decoded at the mobile station is crucial. In the HARQ timeline of FIG. 9, the delay between the subsequent HARQ transmissions is large. Thus, there is a need for reducing the HARQ delay of the system without changing the functional operation of the system.

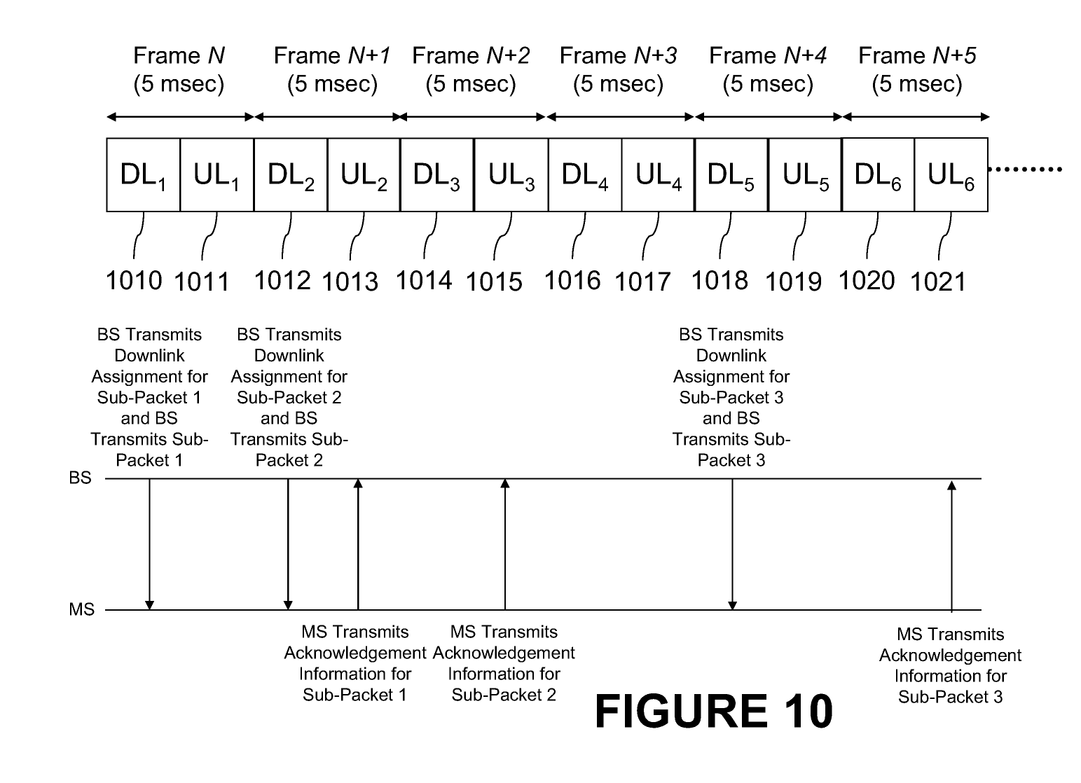

FIG. 10 illustrates a sequence of frames for downlink traffic in accordance with one embodiment of the present invention. Consider that the base station has encoded a packet and has generated multiple sub-packets as previously discussed. In the downlink subframe of frame N (1010), the base station transmits a downlink assignment for sub-packet 1 and transmits sub-packet 1 (the first HARQ transmission) to the mobile station. Since this is a first HARQ transmission, the base station will toggle the AI_SN field and set the ACID to some value. The mobile station decodes the assignment message, determines it has been assigned a radio resource, and then processes the sub-packet received on the determined radio resource.

Prior to receiving acknowledgement information for the first sub-packet, in the downlink subframe of frame N+1 (1012), the base station transmits a downlink assignment for sub-packet 2 and transmits sub-packet 2 (the second HARQ transmission) to the mobile station. Since this is a second HARQ transmission, the base station will not toggle the AI_SN field and will set the ACID to the value used on the first HARQ transmission. The mobile station decodes the assignment message, determines is has been assigned a radio resource, and then processes the sub-packet received on the determined radio resource.

Since this is a second HARQ transmission, the mobile station combines sub-packet 1 and sub-packet 2 prior to decoding. If the mobile station is able to successfully decode the packet after sub-packet 1, the mobile station transmits an acknowledgement (ACK) to the base station in the uplink subframe of frame N+1 (1013). If the mobile station is not able to successfully decode the packet after sub-packet 1, the mobile station transmits a negative acknowledgement (NACK) to the base station in the uplink subframe of frame N+1 (1013).

If the mobile station is able to successfully decode the packet after sub-packets 1 and 2, the mobile station transmits an acknowledgement (ACK) to the base station in the uplink subframe of frame N+2 (1015). If the mobile station is not able to successfully decode the packet after sub-packets 1 and 2, the mobile station transmits a negative acknowledgement (NACK) to the base station in the uplink subframe of frame N+2 (1015). Upon receiving an ACK in either uplink subframe (1013 and 1015), the base station takes no further action for this packet.

Upon receiving a NACK in both uplink subframes (1013 and 1015), in the downlink subframe of frame N+4 (1018), the base station transmits a downlink assignment for sub-packet 3 and transmits sub-packet 3 (the third HARQ transmission) to the mobile station. Since this is a third HARQ transmission, the base station will not toggle the AI_SN field and will set the ACID to the same value that was used on the first and second HARQ transmissions. The mobile station decodes the assignment message, determines it has been assigned a radio resource, and then processes the sub-packet received on the determined radio resource.

By transmitting HARQ sub-packets before receiving acknowledgement information, the base station is able to reduce the delay associated with transmitting HARQ sub-packets without changing the operation of the system. The base station can schedule packets at any time based on any number of received acknowledgements. FIG. 10 is merely intended to provide an example of the improved functionality. For example, in FIG. 10, the base station could have scheduled the third sub-packet in the downlink subframe of frame N+3, having received acknowledgement information for the first sub-packet but not having received acknowledgment information for the second sub-packet. The base station scheduler determines how many sub-packets to transmit in relation to an anticipated number of acknowledgement indications based on an indication of channel quality, success on recent decoding, mobility, and the like. For example, the base station can transmit the same number of sub-packets that was needed for the most recent HARQ packet for the current sub-packet.

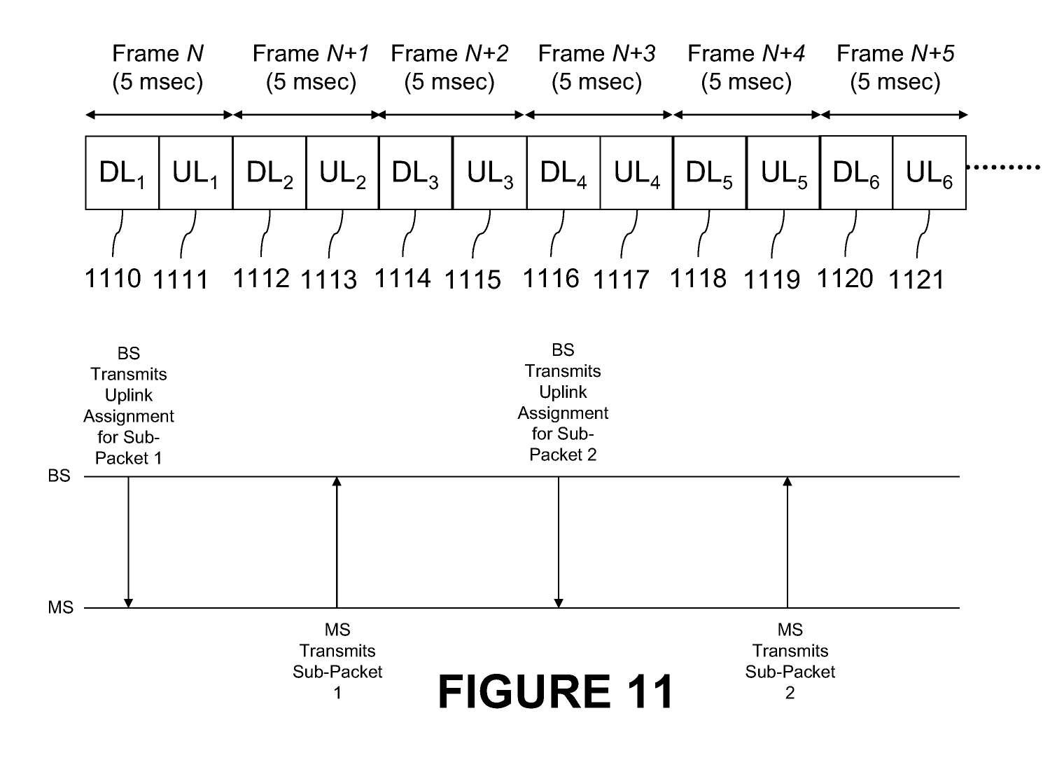

FIG. 11 illustrates a sequence of frames for uplink traffic. In the first subframe of frame N (1110), the base station transmits an uplink assignment for sub-packet 1. The mobile station receives this assignment message, determines its assigned radio resource, encodes a packet, and forms sub-packets. The mobile station transmits the first sub-packet (first HARQ transmission) in the uplink subframe of frame N+1 (1113). If the base station is able to correctly decode the packet after the first HARQ transmission, it takes no further action. If the base station is not able to correctly decode the packet after the first HARQ transmission, it transmits an assignment for sub-packet 2 in the downlink subframe of frame N+3 (1116). The mobile station receives the assignment message, determines its assigned radio resource, and transmits the second sub-packet in the uplink subframe of frame N+4 (1119). This process is repeated for subsequent HARQ transmissions. In some embodiments, the base station transmits acknowledgment information to the mobile station, while in other embodiments, the assignment messages serve as acknowledgement information.

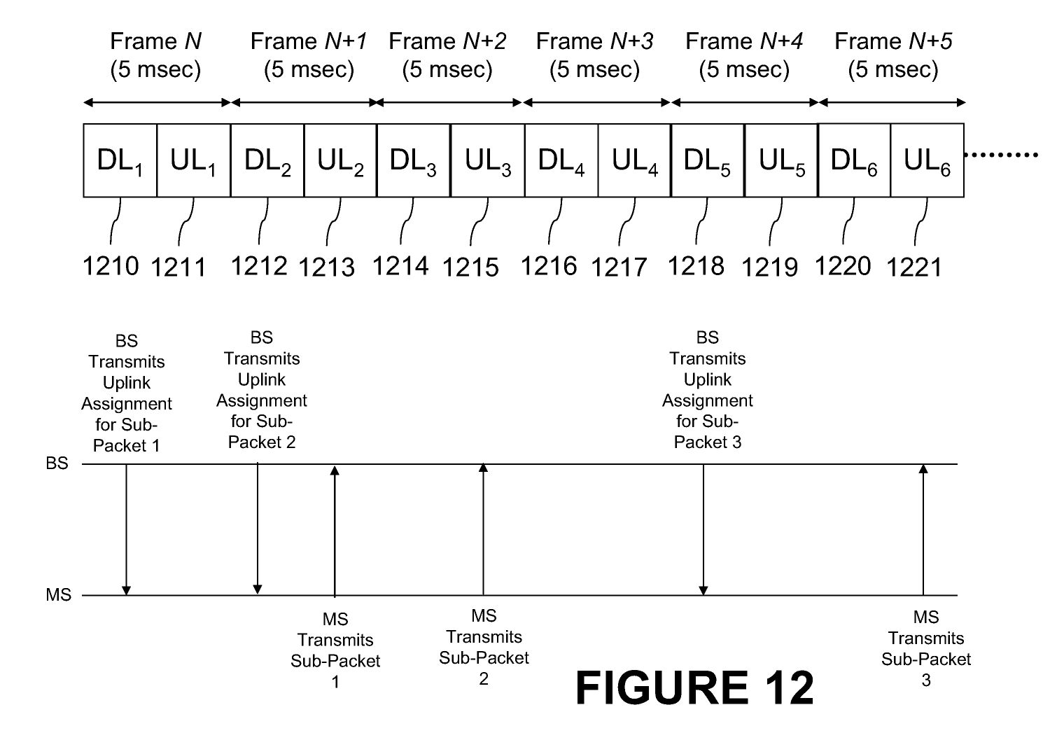

FIG. 12 illustrates a sequence of frames for uplink traffic in accordance with one embodiment of the present invention. In the first subframe of frame N (1210), the base station transmits an uplink assignment for sub-packet 1. The mobile station receives this assignment message, determines its assigned radio resource, encodes a packet, and forms sub-packets. Before the mobile station is able to transmit the first sub-packet, in the downlink subframe of frame N+1 (1212), the base station transmits an uplink assignment message for sub-packet 2. The mobile station transmits the first sub-packet (first HARQ transmission) in the uplink subframe of frame N+1 (1213) and the second sub-packet (second HARQ transmission) in the uplink subframe of frame N+2 (1215). If the base station is able to correctly decode the packet after the first or second HARQ transmission, it takes no further action. If the base station is not able to correctly decode the packet after the first and second HARQ transmission, it transmits an assignment for sub-packet 3 in the downlink subframe of frame N+4 (1218). The mobile station receives the assignment message, determines its assigned radio resource, and transmits the third sub-packet in the uplink subframe of frame N+5 (1221). Like in the downlink case, the base station can transmit as many assignments based on any number of transmitted packets. For example, the base station can transmit uplink assignments in downlink frames N, N+1, and N+2 before it is able to decode the first uplink packet.

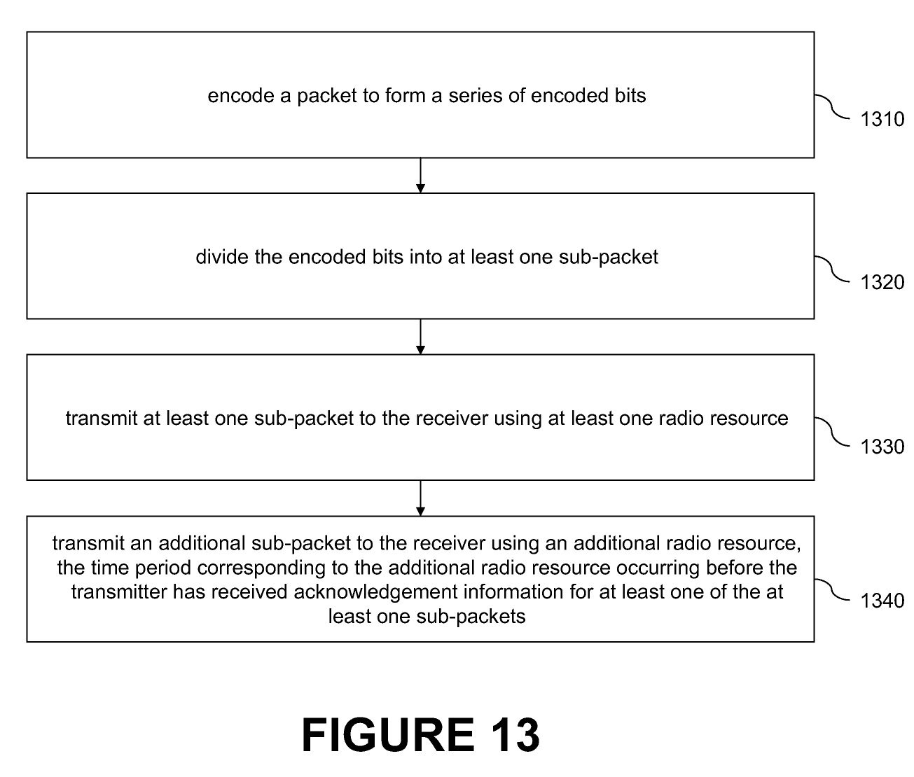

FIG. 13 is a flow chart for base station operation in accordance with one embodiment of the present invention. At step 1310, the base station encodes the packet to form a series of encoded bits. At step 1320, the base station divides the encoded bits into at least one sub-packet. At step 1330, the base station transmits at least one sub-packet to the receiver using at least one radio resource. At step 1340, the base station transmits an additional sub-packet to the receiver using an additional radio resource, the time period corresponding to the additional radio resource occurring before the transmitter has received acknowledgement information for at least one of the at least one sub-packets. The radio resources can be code domain resources, frequency domain resources, time domain resources, spatial domain resources, combinations, and the like. In some embodiments, the additional radio resource occurs in the same time period as at least one of the least at one radio resource. For example, the additional radio resource can be in the same frame as at least one of the at least one radio resource. In other embodiments, the additional radio resource occurs subsequent in time to the at least one radio resource. In some embodiments, wherein chase combining is used, the at least one sub-packet and the additional sub-packet are the same. In other embodiments, wherein incremental redundancy is used, the at least one sub-packet and the additional sub-packet do not contain the same set of encoded bits.

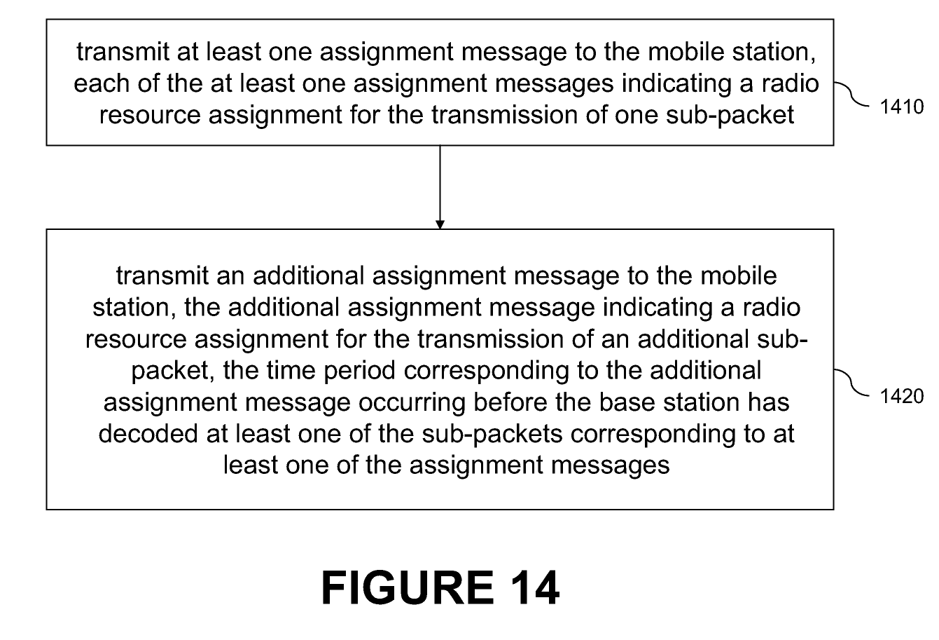

FIG. 14 is a flow chart for base station operation in accordance with another embodiment of the present invention. At step 1410, the base station transmits at least one assignment message to the mobile station, each of the at least one assignment messages indicating a radio resource assignment for the transmission of one sub-packet. At step 1420, the base station transmits an additional assignment message to the mobile station, the additional assignment message indicating a radio resource assignment for the transmission of an additional sub-packet, the time period corresponding to the additional assignment message occurring before the base station has decoded at least one of the sub-packets corresponding to at least one of the assignment messages.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for transmitting a packet from a transmitter to a receiver, the method comprising:
encoding a packet to form a series of encoded bits;
dividing the encoded bits into a plurality of sub-packets;
transmitting a first sub-packet to a receiver over a wireless communication network; and
transmitting a second sub-packet to the receiver over the wireless communication network, the second sub-packet being transmitted prior to receiving acknowledgement information for the first sub-packet.

2. The method of claim 1, wherein the first sub-packet and the second sub-packet are the same sub-packet.

3. The method of claim 1, wherein the first sub-packet and the second sub-packet do not contain the same set of encoded bits.

4. The method of claim 1, wherein transmitting the first sub-packet comprises transmitting the first sub-packet to the receiver using a first radio resource and wherein transmitting the second sub-packet comprises transmitting the second sub-packet to the receiver using a second radio resource.

5. The method of claim 4, wherein the second radio resource occurs subsequent in time to the first radio resource.

6. The method of claim 4, wherein the second radio resource occurs at the same time period as the first radio resource.

7. The method of claim 4, wherein the first radio resource and the second radio resource correspond to portions of a frequency domain.

8. The method of claim 4, wherein the first radio resource and the second radio resource correspond to portions of a code domain.

9. The method of claim 4, wherein the first radio resource and the second radio resource correspond to portions of a spatial domain.

10. The method of claim 1, wherein the first and second sub-packets comprise HARQ (of a hybrid automatic repeat-request) sub-packets.

11. A method for transmitting a packet from a transmitter to a receiver, the method comprising:
encoding a packet to form a series of encoded bits;
dividing the encoded bits into a plurality of sub-packets;
transmitting a first sub-packet to a receiver over a wireless communication network;
transmitting a second sub-packet to the receiver over the wireless communication network; and
receiving acknowledgement information related to the first sub-packet after transmitting the first and second sub-packets.

12. The method of claim 11, wherein the acknowledgement information comprises a negative acknowledgement, the method further comprising transmitting a third sub-packet in response to the negative acknowledgement.

13. The method of claim 11, further comprising transmitting a third sub-packet to the receiver over the wireless communication network before receiving the acknowledgement information.

14. The method of claim 11, wherein the first and second sub-packets comprise HARQ (of a hybrid automatic repeat-request) sub-packets.

15. A method in a base station for assigning radio resources to a mobile station for transmission of a plurality of sub-packets, the method comprising:
transmitting an assignment message to the mobile station, the assignment message indicating a radio resource assignment for transmission of one sub-packet; and
transmitting an additional assignment message to the mobile station, the additional assignment message indicating a radio resource assignment for transmission of an additional sub-packet, the additional assignment message being transmitted before the base station has decoded any acknowledgement information corresponding to the assignment message.

16. The method of claim 15, wherein the radio resource assignment correspond to portions of a frequency domain.

17. The method of claim 15, wherein the radio resource assignment correspond to portions of a code domain.

18. The method of claim 15, wherein the radio resource assignment correspond to portions of a spatial domain.
